(19) United States
(12) Patent Application Publication
(10) Pub. No.: US 2009/0240510 A1
(43) Pub. Date: Sep. 24, 2009

(54) Balanced Scorecard Method for Determining an Impact on a Business Service Caused by Degraded Operation of an IT System Component

(76) Inventors: Lloyd B. Hopkins, Manchester (GB); Colin Griffiths, Manchester (GB); Andrew D. Johnson, New York, NY (US); Jonathan D. Miles, Manchester (GB); Paul Bosomworth, Manchester (GB); Grant Glading, Manchester (GB)

Correspondence Address: Russ Weinzimmer, 614 Nashua Street, Suite 53, Milford, NH, 03055, US

(21) Appl. No.: 12/050,339

(22) Filed: Mar. 18, 2008

(51) Int. Cl. G06Q 10/00

(52) U.S. Cl. 705/1

(57) ABSTRACT

A “balanced scorecard” method is disclosed for determining degrees of impact on business service elements (BSE's) caused by degradations of configuration items (CI's) in an underlying IT system. The formulas are used by an Impact Calculation Engine (ICE) of a Business Services Management (BSM) system. They provide enhanced accuracy by accounting for “service aspects” of alerts (using categories such as performance, availability, security, end user, capacity, and financial) and/or degrees of CI degradation (in some embodiments using OSI Standards). The method eliminates manual assignment of degrees of impact. Preferred embodiments convert alerts to a common alert format, determine a separate degree of impact for each service aspect, and use default formulas when custom formulas are not provided. Some embodiments use a service subscription wizard to at least partly automate the assignment of CI-to-BSE relationships. Different balanced scorecards can apply to the same BSE at different times, dates, usage levels, etc.

### FIELD OF THE INVENTION

The invention generally relates to management of Information Technology systems, and more specifically to business services management systems.

### BACKGROUND OF THE INVENTION

Almost every business uses some form of “Information Technology” system, or IT system, to support various activities that contribute to the delivery of a product and/or a service. A typical business IT system is composed of a plurality of “Configuration Items” or “CI's” that can include personal computers, printers, fax machines, scanners, routers, servers, and such like. Depending on its nature and size, a business can be partly or even totally dependent on its IT system or systems, and may not be able to deliver its products and/or services if the IT system fails.

Many businesses offer services that are delivered mostly or even entirely by IT systems, with little or no direct human activity. Examples include automated bank tellers, online banking systems, online travel reservation systems, online dating services, online auction sites, and such like. The IT systems that enable these kinds of complex business services are typically very large, being composed of hundreds, thousands, or even tens of thousands of CI's that are frequently distributed over multiple locations.

Most large IT systems include software and tools that track individual CI's and issue one or more “alerts” whenever the operation of a CI is degraded in some way. Additional software and hardware tools are often used to track these alerts and to provide for convenient monitoring of the IT system. However, in the case of very large IT systems that support complex business services it can be difficult to relate CI degradations and failures to actual impacts on business services. For example, complete failure of one CI may have very little impact, while even a slight degradation of another CI may have significant consequences. Hence, time and effort can be inefficiently expended, and delivery of services (and hence revenues) can be unnecessarily reduced, if CI problems are addressed only on the basis of the severity of the CI failures.

Business Services Management, or BSM, is a type of software management tool that addresses this problem by relating CI's to business services and using these relationships to determine the impact that degradation or failure of a CI will have on the business service. In many cases, a business service is conceptually divided into a plurality of business service elements (BSE's), and CI's are related to the BSE's so as to better characterize the impact of a CI degradation.

While BSM systems are a significant improvement compared to traditional IT monitoring systems, known BSM systems suffer from several problems that limit their practicality and accuracy. From a practical standpoint, implementation of a BSM system typically requires manual assignment of relationships of CI's to BSE's, as well as manual assignment of degrees of impact, usually expressed as percentages, to each CI-to-BSE relationship. For IT systems that include thousands or even tens of thousands of CI's, this process can be prohibitive.

Tools are sometimes available to aid in the assignment of CI's to BSE's. For example, auto discovery tools and application dependency mapping tools can provide a list or hierarchy of CI's that are then assigned to a BSE. However, significant manual data cleansing and manipulation is still usually required.

In addition, calculating the BSE impact of CI failures by simply identifying which CI's have failed, noting which BSE's the CI's are related to, and totaling up the pre-assigned percentages of impact of the associated CI-to-BSE relationships is simplistic, and can provide only a very approximate estimate of the true impact of CI degradation on the functioning of a business service.

### SUMMARY OF THE INVENTION

A method is claimed that uses an impact calculation engine which incorporates the use of formulas contained in one or more “balanced scorecards” to determine the degree of impact on business services and/or business service elements (BSE's) caused by degraded operation of a CI that is part of an underlying IT system. The balanced scorecard formulas provide an accurate determination of business service or BSE impacts by taking into account the natures or types of CI degradation, herein referred to as CI service aspects, and/or the degrees of severity of the CI degradations. Use of balanced scorecards also eliminates the need to manually assign degrees of impact to each CI-to-BSE relationship.

Balanced scorecards contain definitions detailing required service levels for business services. These usually include multiple requirements tracked over specific periods of time. The definitions form part of the data used in the balanced scorecard and are considered by the impact calculation engine when ascertaining service impacts.

Preferred embodiments provide an even more accurate determination of impacts by determining separate degrees of impact for each type of service aspect. Further preferred embodiments minimize the difficulty of implementing the method by using default balanced scorecard formulas whenever custom formulas are not provided, thereby eliminating the need to manually provide a balanced scorecard for every combination of BSE and service aspect. In addition, some preferred embodiments employ a service subscription wizard that automatically specifies and stores at least some CI-to-BSE relationships, initially and/or on an ongoing basis, thereby improving the accuracy of the CI-to-BSE database and consequently enhancing the accuracy of impact determinations. Use of a service subscription wizard also reduces or eliminates the need to manually assign CI-to-BSE relationships, thereby greatly reducing the difficulty of implementing and maintaining the method.

The method includes receiving alerts regarding degraded operation of CI's, extracting CI identities from the alerts, and determining the BSE's to which the degraded CI's are related. The method further includes extracting from each alert the nature of the CI degradation (herein referred to as the “service aspect”) and/or the severity of the CI degradation, and determining the impacts on the BSE's according to “balanced scorecard” formulas that take into account the service aspects and/or the severities of the alerts.

In preferred embodiments, alerts are converted into a common alert format that allows information to be extracted from all received alerts in a consistent manner. In some preferred embodiments CI-to-BSE relationships are determined at least partly by retrieving information from a Configuration Management Database (“CMDB”) included in the IT system. In some of these embodiments, a “reconciliation engine” is used to assist in reconciling the formats of CI identifying information as supplied in alerts and as used in the CMDB.

In other preferred embodiments, each service aspect extracted from an alert is characterized by assigning it to a service aspect category, and in some of these embodiments the service aspect categories include performance, availability, security, end user, capacity, and/or financial. In still other preferred embodiments severities of CI degradation are assigned according to the Open Systems Interconnect (“OSI”) standard.

In preferred embodiments a default balanced scorecard is used to determine the impacts of degraded CI's on BSE's except when it is overridden by a custom balanced scorecard, and in some of these embodiments balanced scorecards can be applicable only to a subset of the BSE's that includes at least one BSE, and/or a custom balanced scorecard can be applicable only to a subset of service aspect categories that includes at least one service aspect category.

In further preferred embodiments, more than one balanced scorecard can be associated with the same BSE and service aspect, such that exactly one of the balanced scorecards is applicable under any set of circumstances, but different balanced scorecards are applicable under different sets of circumstances. These sets of circumstances are sometimes referred to as Service Level Agreement Criteria, or “SLAC's.” In some of these embodiments, the SLAC's under which different balanced scorecards are applicable to the BSE and service aspect include different times of day, different dates of the year, different days of the week, different usage levels of the BSE, different usage levels of the business service, and/or other user defined criteria, such as IC usage levels or network traffic levels In addition, it is possible to manually select the desired balanced scorecard in real-time. A collection of one or more SLAC's can be applied to any individual BSE or a group of BSE's.

In preferred embodiments, the method further includes a service subscription wizard that at least partly automates the assignment of relationships of CI's to BSE's, In some of these preferred embodiments the service subscription wizard automatically assigns relationships of CI's to BSE's during the initial implementation of the method, and in some of these preferred embodiments the service subscription wizard automatically creates and modifies assigned relationships of CI's to BSE's on an ongoing basis whenever a CI is added to the IT system, a CI is removed from the IT system, and/or the usage of a CI within the IT system is modified.

### BRIEF DESCRIPTION OF THE DRAWINGS

FIG. 1A is a functional diagram that illustrates the basic elements included in a typical BSM system of the prior art;

FIG. 1B is a functional diagram that illustrates the structure of a typical BSM configuration model of the prior art;

FIG. 1C is an example of the structure of FIG. 1B applied to an online banking business service;

FIG. 2 is a functional diagram that illustrates how BSE impacts caused by degraded operation of a CI are determined in a typical BSM system of the prior art;

FIG. 3 is a functional diagram that illustrates how BSE impacts caused by degraded operation of a CI are determined in a preferred embodiment of the present invention;

FIG. 4 is a table that presents examples from a preferred embodiment of rules used to extract service impacts from alerts;

FIG. 5 is a table that presents examples from a preferred embodiment of rules used to assign OSI degrees of severity to numerical severity levels extracted from alerts;

FIG. 6 is a table that presents a default balanced scorecard from a preferred embodiment;

FIG. 7 is a table that presents a custom balanced scorecard from a preferred embodiment; and

FIG. 8 is a table that presents examples of service subscription rules used by a service subscription wizard in a preferred embodiment.

### DETAILED DESCRIPTION OF PREFERRED EMBODIMENTS

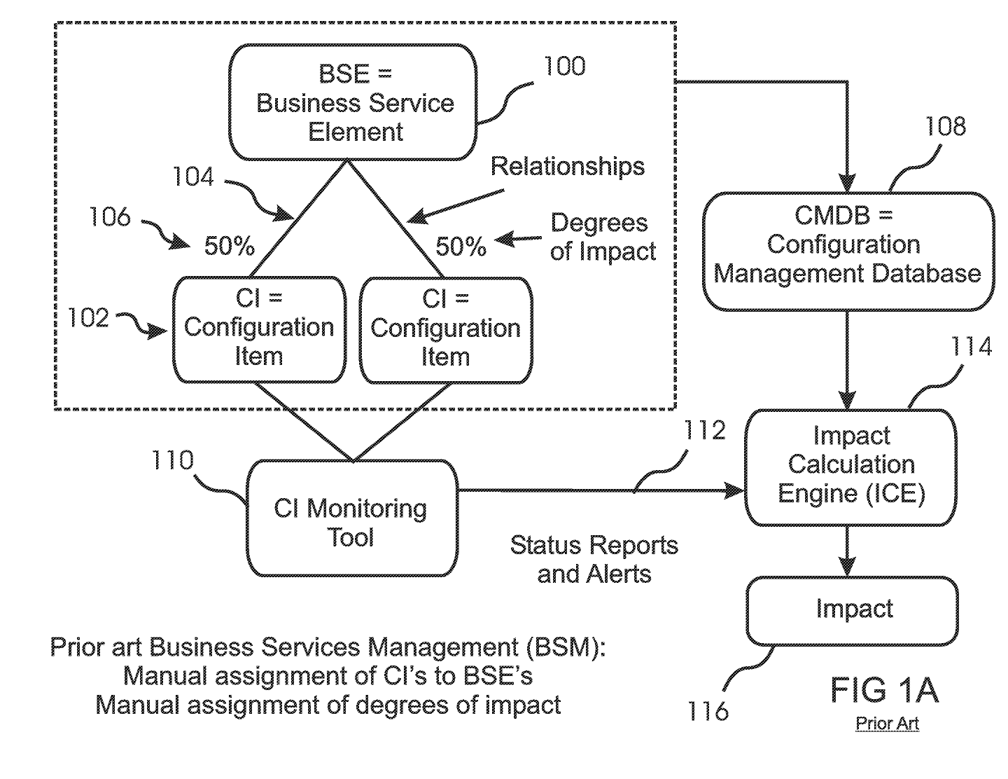

With reference to FIG. 1A, a business service, or a business service element (BSE) 100 within a business service, is supported by an IT system composed of a plurality of configuration items (CI's) 102 such as servers, routers, printers, databases, user nodes, and such like. In a typical business services management (BSM) system of the prior art, relationships 104 of CI's to BSE's are manually assigned, and degrees of impact 106, usually expressed as percentages, are manually assigned to the relationships 104. For example, if two servers 102 support a specific BSE 100, each of the servers 102 might be assigned a degree of impact 104 on that BSE 100 of 50%. An enumeration of the CI's 102 in the IT system together with the CI-to-BSE relationships 104 and associated degrees of impact 106 are typically stored by a prior art BSM in a Configuration Management Database, or “CMDB” 108.

IT systems that support complex business services usually include software and/or hardware tools 110 that monitor the CI's 102 and issue reports 112 on CI status, and when the operation of a CI becomes degraded or is anticipated to become degraded, due to a failure, a slowdown, a rise in usage above acceptable limits, and such like, these software and/or hardware tools 110 generate alerts 112 that contain diagnostic information such as the identity of the CI, the nature of the degradation (CPU, login, and such like) and the severity of the degradation (100%, 50%, and such like). In a typical prior art BSM system, these status reports and alerts 112 are received by an Impact Calculation Engine (“ICE”) 114 that analyzes the status reports and alerts 112 according to information obtained from the CMDB 110 and estimates the resulting degrees of impact 116 on the BSE's

FIG. 1B is a conceptual diagram of a configuration model for a business service 118 that is composed of a plurality of BSE's 100. In general, each CI 102 can be related 104 to more than one BSE 100. The degrees of impact 106 do not necessarily total 100% for each BSE 100. For example, a BSE 100 may be related to more than one CI 102, but failure of only one of the related CI's 102 may cause total failure of (100% impact to) the BSE 100. Also, degrees of impact can reflect the priorities of a business, as well as impacts on functionality. Even a slight degradation of a BSE 100 that is vital to generating sales or revenue may be assigned a higher degree of impact than complete failure of a BSE 100 that is less critical to the success of the business. In general BSE's 100 can be subdivided into a plurality of daughter BSE's 120. In such cases, manual assignment are included in the CMDB 108 of degrees of impact 106 of the daughter BSE's 120 on the parent BSE's 100.

An example of the configuration model of FIG. 1B is presented in FIG. 1C, where the business service 118 is an online banking service, the BSE's 100 include subcomponents such as logging in, checking balances, transferring funds, and opening accounts. The opening accounts BSE 100 is further divided into daughter BSE's 120 than include entry of customer details and verification of the customer's social security number. The CI's 102 include several servers, routers, and databases, and in general a BSE 100 is dependent on more than one CI 102 and a CI 102 can be related to more than one BSE 100. Note that FIG. 1C is intended only to be illustrative, and shows only a small part of what would be included in an actual online banking service and underlying IT system.

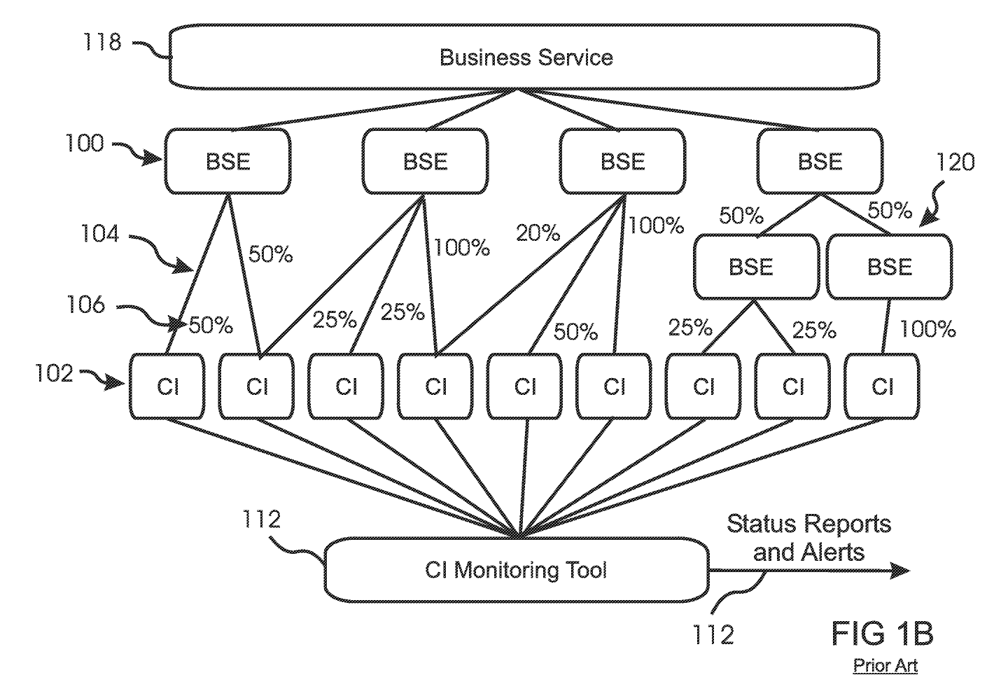

FIG. 2 illustrates the operation of an impact calculation engine (ICE) used in a typical prior art BSM system to determine the impact of a degraded CI 102 on a BSE 100, 120. Upon actual or anticipated degradation of the operation of the CI 102, an alert 200 is issued by a CI monitoring tool 112. The alert is analyzed, or “parsed,” 202 to determine the identity 204 of the degraded CI 102 that gave rise to the alert 200. Information is then retrieved regarding the CI 102 from a Configuration Management Database (CMDB) 108 that has been previously populated 206 with relationships 104 of CI's 102 to BSE's 100, 120 and with degrees of impact 106 assigned to the relationships 104.

Typically, in the prior art, relationships 104 of CI's 102 to BSE's 100, 120 are entered manually into the CMDB 108. Degrees of impact 106 of the relationships 104 are entered either manually, or according to a simplified calculation method. For example, if 10 server CI's are related 104 to a certain BSE 100, 120, some prior art systems will automatically assign an equal degree of impact 106 to each of the 10 relationships 104, storing a 10% degree of impact 106 in the CMDB 108 for each of the relationships 104. Regardless of how they are entered, degrees of impact 106 are typically stored in the prior art as fixed values in the CMDB 108.

Once the information is retrieved from the CMDB 108 regarding relationships 104 and degrees of impact 106, a simple calculation 208 then adds together the degrees of impact 106 from all alerts 200 for each BSE 100, 120 so as to determine an estimated overall service impact 210 for each BSE 100, 120. Typically, for such prior art BSM's, a degraded CI 102 is treated as having simply failed, with no regard for the nature or the degree of severity of the degradation.

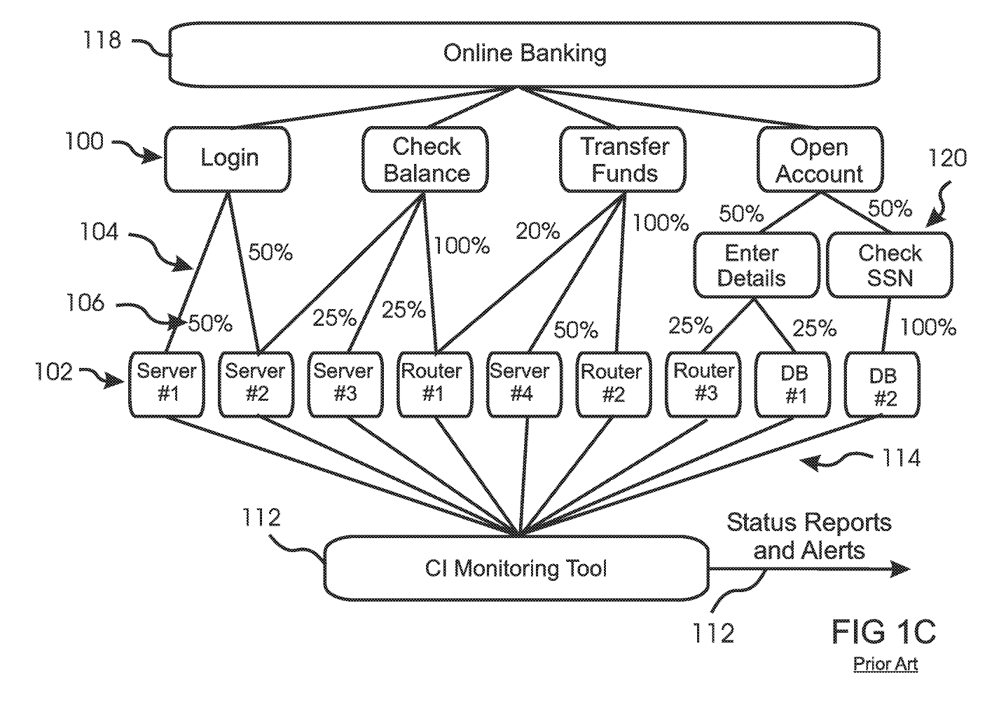

In contrast, FIG. 3 illustrates the process used by a preferred embodiment of the present invention to determine the impact of a degraded CI 102 on a BSE 100, 120. When an alert 200 is generated due to actual or anticipated degradation of the operation of a CI 102, the alert 200 is first converted to a common alert format 300. In general, alerts 200 are generated by different and often unrelated software and hardware tools that may be provided by different manufacturers or third party vendors of CI monitoring tools 112. Thus, while alerts 200 are usually issued as text messages, they can differ significantly in their formats. As is discussed below, the current invention relies on extracting more information from alerts 200 than is typical of the prior art, and so it is useful in preferred embodiments of the present invention to convert alerts 200 into a common alert format 300 so that subsequent analysis can be carried out in a consistent fashion.

Once an alert 200 has been converted into a common alert format 300, it is analyzed, or “parsed” 302, and the identity of the degraded CI 204 is extracted, along with the nature of the degradation, herein referred to as the service aspect 304, and the severity of the degradation, which in preferred embodiments is converted to a standard Open Systems Interconnect or OSI severity 306. In the preferred embodiment of FIG. 3, the service aspect 304 is characterized by assigning it to a standard service aspect category, where the standard service aspect categories are performance, availability, security, end user, capacity, and financial.

The identity of the degraded CI 204 extracted from the alert 200 is compared to a Configuration Management Database (CMDB) 108 that contains information regarding relationships 104 of CI's 102 to BSE's 100, 120. In the preferred embodiment of FIG. 3, at least some of the CI-to-BSE relationships 104 stored in the CMDB 108 are automatically determined by a service subscription wizard 308 that uses subscription rules to automatically assign CI's 102 to BSE's 100, 120, both when the BSM system is initially implemented and on an ongoing basis as changes are made to the IT infrastructure.

If the identifier for the CI 204 stored in the CMDB 108 does not match the CI identifier 204 that is included in the alert 200 generated by the CI monitoring tool 112, a reconciliation engine 303 is used to map the CI identifier 204 in the alert 200 to the identifier stored in the CMDB 108. The reconciliation engine 303 uses sample alerts from the CI monitoring tool 112 to help a user understand the identifier format used in alerts 200 generated by the CI monitoring tool 112 and compare it to the format of the corresponding identifier stored in the CMDB 108. In preferred embodiments, the reconciliation engine 303 does this by highlighting details of where the formats do not match. The user can then modify either the source data for the CMDB 108 or the alert format from the CI monitoring tool 112. In preferred embodiments, basic rules can also be established and used to automatically reformat identifiers from alerts 200 so as to match the format used in the CMDB 108.

Once information has been retrieved from the CMDB 108 regarding BSE's 100, 120 that have relationships 104 to degraded CI's that have caused alerts 200, this information is combined with the service aspect 304 and OSI severity 306 information also parsed 302 from the alert 200, and a balanced scorecard formula 310 that takes all of this information into account is used to determine the cumulative impact 312 of all currently active alerts on each service aspect of each BSE 100, 120. In the case of parent BSE's 100, 120 that are composed of daughter BSE's 120, each alert that is related to a daughter BSE 120 is considered to also be related to the parent BSE 100, 120 for purposes of determining impacts using the balanced scorecard 310. In the preferred embodiment of FIG. 3, custom balanced scorecards 310 can be specified wherever needed for any specific service aspect of any specific BSE 100, 120, or for any combination of service aspects and BSE's 100, 120. For example, a custom balanced scorecard 312 could apply only to the performance service aspect of a login BSE 100, 120, it could apply to all service aspects of a login BSE 100, 120, it could apply to only the performance and security service aspects of only the login and transfer funds BSE's 100, 120, and so forth. Multiple custom balanced scorecards 312 can also be supplied for the same combination of service aspect(s) and BSE(s) 100, 120, such that different custom balanced scorecards 312 are active under different conditions. For example, one custom balanced scorecard 312 could apply during daytime business hours, while another custom balanced scorecard 312 could apply outside of daytime business hours. Or different custom balanced scorecards 312 could apply on week days and on weekends. Another possibility is that different custom balanced scorecards 312 could apply at different levels of usage of a business service 118 or a BSE 100, 120. Whenever a custom balanced scorecard 312 is not specified, a default balanced scorecard 312 is used.

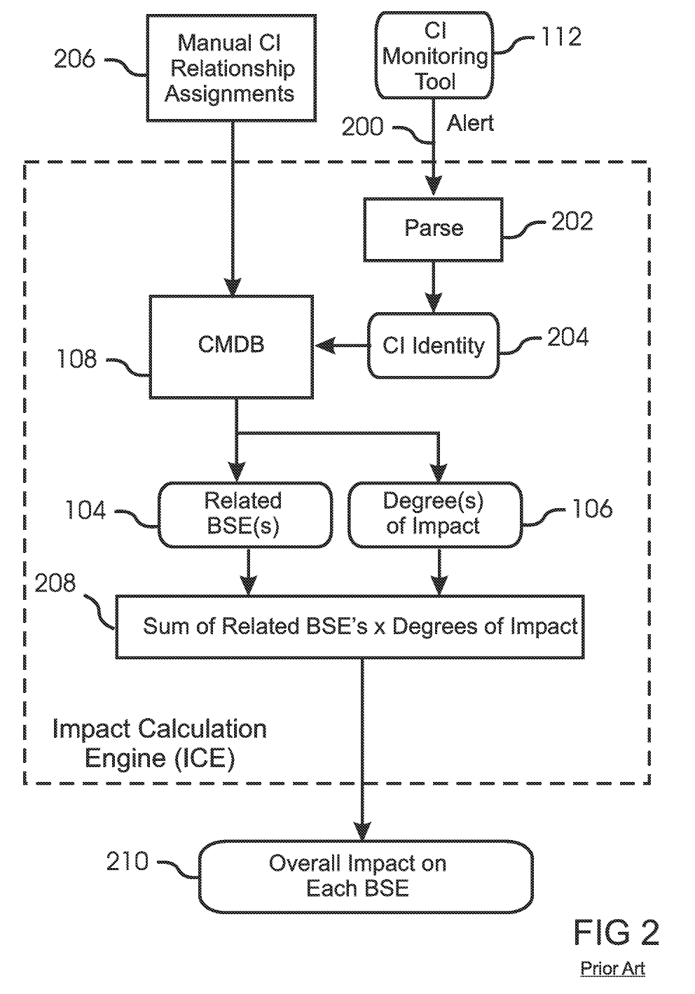

FIG. 4 is a table that gives example of rules that are used to assign service aspects 304 extracted from alerts 200 to service aspect categories. In these examples, after an alert 200 is converted into the common alert format 300 and parsed 302, a so-called “object class” 400 of the alert 200 is extracted and a service aspect category 402 is assigned according to the text of the object class 400. Specifically, in the example of FIG. 4, any alert 200 with an object class 400 containing the text “CPU” 404 is assigned to the “Performance” category 406, while any alert 200 with an object class 400 containing the text “Login” 404 is assigned to the “security” service aspect category 406.

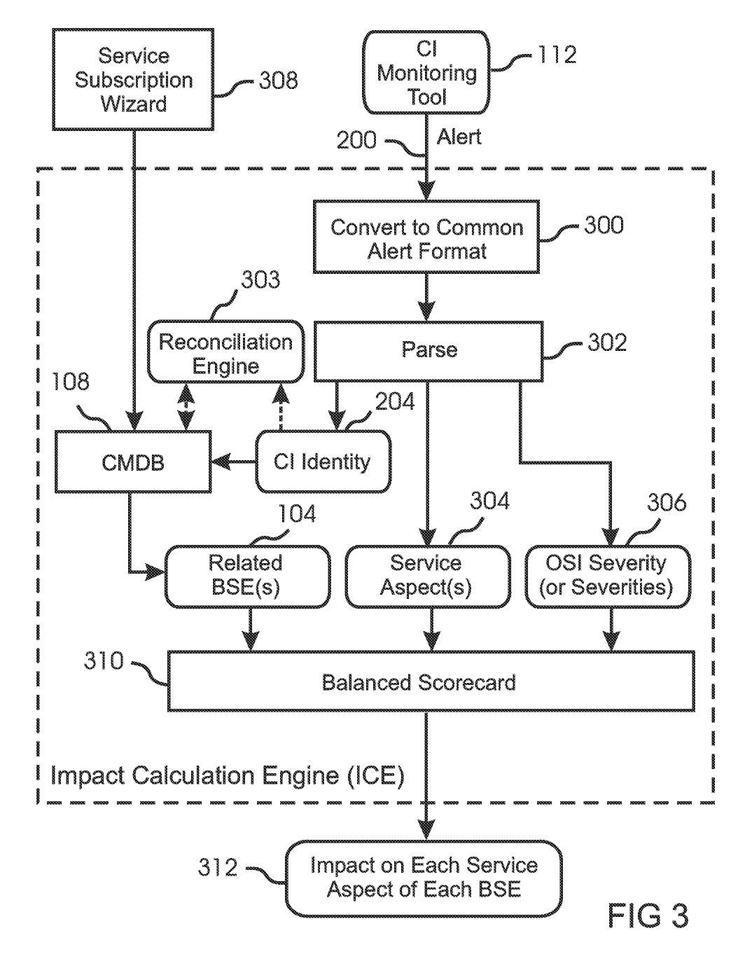

An example is given in the table of FIG. 5 of similar rules that are used to assign degrees of severity 500 extracted from parsed alerts to OSI standard severity levels 306, 502. This example applies to alerts generated by a CI monitoring tool 112 that happens to assign numerical degrees of severity 500 to alerts 200, where the numerical values range from 0 to 100. Numerical severities greater than 80 504 are deemed to be “critical” 506, between “70” and “80” 504 they are deemed to be “major” 506, severities between 60 and 70 504 are considered “minor” 506, those between 50 and 60 504 are “warnings” 506, severities between 40 and 50 504 are deemed for “information” only 506, and below 40 504 the severity is considered to be an indication that there is no degradation of the CI, which is expressed as an OSI severity of “clear” 506.

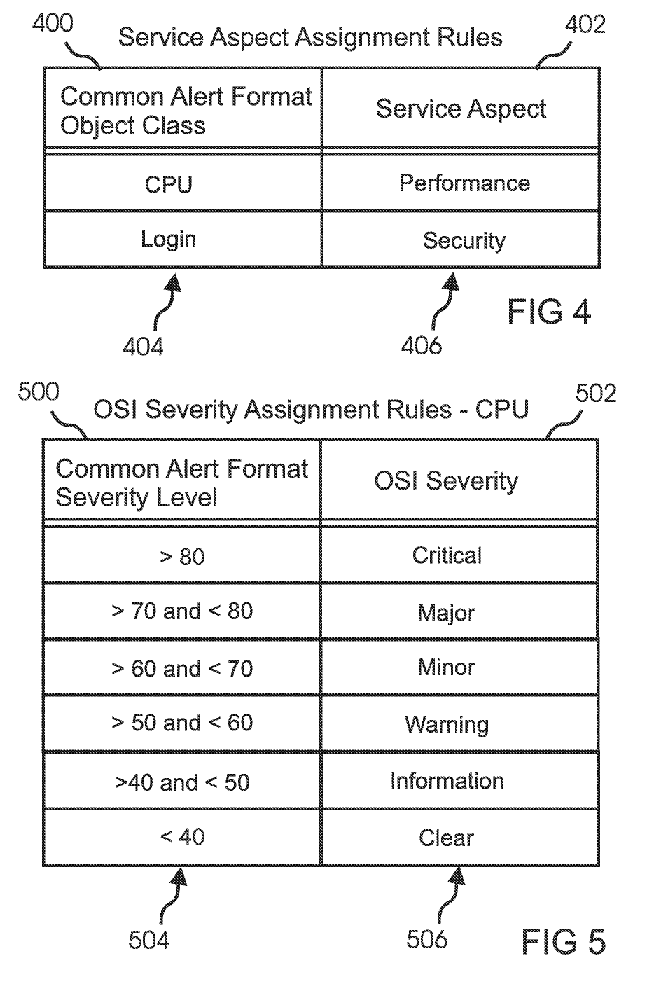

A default balanced scorecard formula 310 of a preferred embodiment is illustrated in the table of FIG. 6. A total is compiled of all alerts 200 received 600 according to the service aspect 304 and OSI severity level 306 of each alert 200. The resulting impact 602 on each service aspect 304 of each BSE 100, 120 is then determined according to the rules specified in the balanced scorecard 310. In the preferred embodiment of FIG. 6, if even one critical alert 200 is received 604, the impact on all related BSE's 100, 120 for the service aspect 304 of that alert 200 is determined to be 100% 606. Similarly, a single major alert results in an impact of 75% on all related BSE's 100, 120 for the service aspect 304 of the alert 200. If more than one alert 200 causes an impact on the same service aspect 304 of the same BSE 100, 120, the impact that is greatest among the alerts is determined to be the impact on that service aspect 304 of that BSE 100, 120.

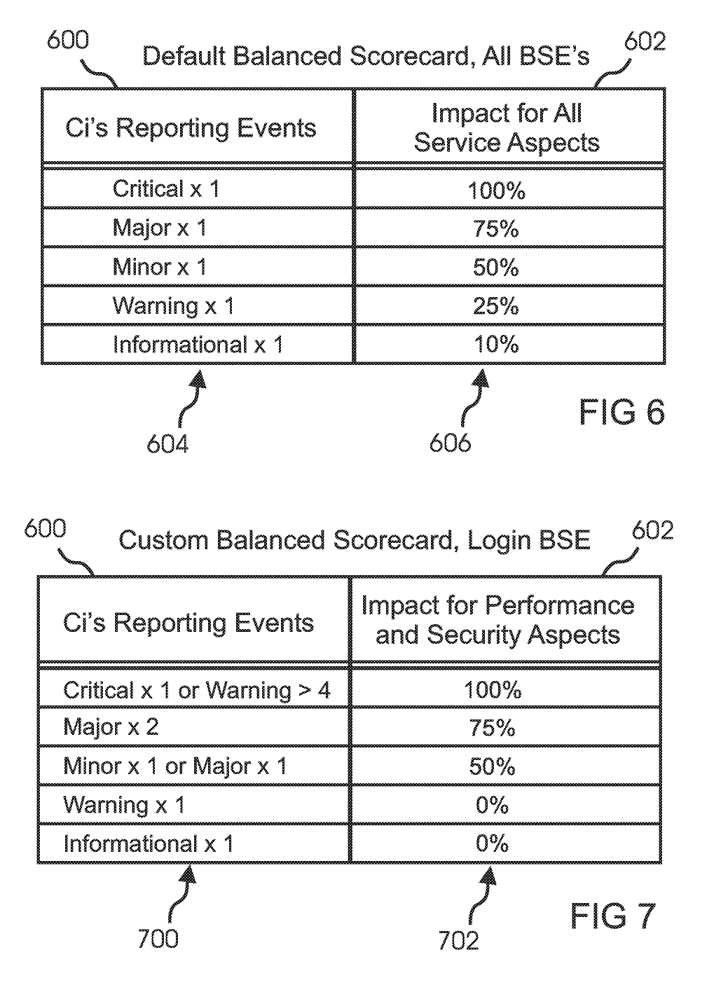

FIG. 7 presents a table that describes a custom balanced scorecard 310 of a preferred embodiment. The custom balanced scorecard 310 applies only to the Login BSE 100, 120, and only to the Performance and Security service aspects 304. According rules given in the table 700, a single alert 200 with a critical OSI severity level 306 from a CI 102 related to the login BSE 100, 120 and with a Performance or Security service aspect 304 will result in a 100% impact 702 on that service aspect 304 of that BSE 100, 120. In addition, while a single alert 200 with a warning OSI severity level 306 will have no impact 702, if four or more such alerts 200 are received, the impact will be determined to be 100%. Similarly, a single alert 200 related to the Login BSE 100, 120 with a Performance or Security service aspect 304 and with an OSI severity level 306 of Major will have only a 50% impact 702, and two or more such alerts 200 are required before there is a 75% impact 702.

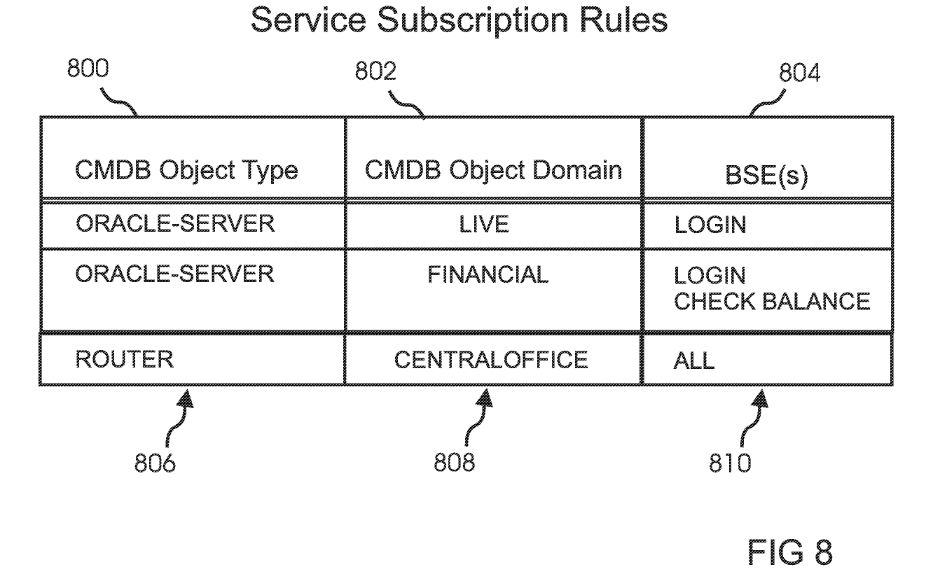

FIG. 8 is a table that presents examples of rules used by a service subscription wizard 308 in a preferred embodiment to automatically enter relationships of CI's 102 to BSE's 100, 120 into a CMDB 108. In this example, information is retrieved by the service subscription wizard 308 from information resources provided by the IT system regarding CI's 102 included in the IT system. The information includes “Object Types” 800 that designate the types of CI's 102 and “Object Domains” 802 that designate the sections of the IT system where the CI's 102 are implemented. Rules have been entered into the service subscription wizard 308 that assign CI's 102 to BSE's 100, 120, 804 according to their object type 800 and object domain 802. For example, an Oracle server 806 in the “Live” domain 808 will be recorded in the CMDB 108 as being related to the Login BSE 100, 120. An Oracle server 806 in the Financial domain 808 will be recorded in the CMDB 108 as being related to both the Login and Check Balance BSE's 100, 120. And a Router 806 in the Central Office domain 808 will be recorded in the CMDB 108 as being related to all BSE's 100, 120.

Other modifications and implementations will occur to those skilled in the art without departing from the spirit and the scope of the invention as claimed. Accordingly, the above description is not intended to limit the invention except as indicated in the following claims.

What is claimed is:

1. A method for analyzing alerts regarding degraded operation of Configuration Items (“CI's”) so as to determine impacts on business service elements (“BSE's”) that compose a business service, the CI's being part of an IT system that supports the business service and each CI being related to at least one BSE, the method comprising:
receiving the alerts;
extracting from the alerts identities of the CI's;
determining the BSE's to which the CI's are related;
extracting from each alert at least one of the nature of the degraded operation (herein referred to as the “service aspect”) and the severity of the degraded operation; and
determining the impacts on the BSE's caused by the degraded operation of the CI's according to “balanced scorecard” formulas that take into account the at least one of the service aspects and the severities of the alerts.

2. The method of claim 1, further comprising converting alerts after they are received into a common alert format that allows information to be extracted from all received alerts in a consistent manner.

3. The method of claim 1, wherein determination of the BSE's to which the CI's are related is accomplished at least partly by obtaining information from a Configuration Management Database (“CMDB”) in which at least some relationships between CI's and BSE's are stored.

4. The method of claim 3, further comprising a reconciliation engine that at least facilitates the association of information identifying a CI in an alert with information identifying the CI in the CMDB.

5. The method of claim 1, wherein each service aspect extracted from an alert is characterized by assigning the service aspect to a service aspect category.

6. The method of claim 5, wherein the service aspect categories include at least one of performance, availability, security, end user, capacity, and financial.

7. The method of claim 1, wherein severities of degraded CI operation extracted from alerts are assigned values according to the Open Systems Interconnect (“OSI”) standard.

8. The method of claim 1, wherein a default balanced scorecard is used to determine the impacts on BSE's of degraded operation of CI's except when a custom balanced scorecard is applicable.

9. The method of claim 1, wherein a balanced scorecard can be applicable only to a subset of the BSE's that includes at least one BSE.

10. The method of claim 1, wherein a balanced scorecard can be applicable only to a subset of service aspects that includes at least one service aspect.

11. The method of claim 1, wherein a plurality of balanced scorecards can be associated with the same BSE and service aspect, such that exactly one of the plurality of balanced scorecards is applicable to the BSE and service aspect under any set of circumstances but different balanced scorecards from the plurality of balanced scorecards are applicable to the BSE and service aspect under different sets of circumstances.

12. The method of claim 11, wherein the balanced scorecard that is applicable to the BSE and the service aspect is selected from the plurality of balanced scorecards associated with the BSE and the service aspect by at least one of real time manual selection, and automatic selection according to at least one of:
a time of day;
a date;
a day of the week;
a usage level of the BSE;
a usage level of the business service;
a usage level of a;
a network traffic level; and
other service level agreement criteria, herein referred to as SLAC's.

13. The method of claim 12, wherein a SLAC can be used in relation to more than one BSE as a criterion for selecting an applicable balanced scorecard.

14. The method of claim 1, wherein at least some of the balanced scorecard formulas provide a separate degree of impact for each service aspect extracted from an alert.

15. The method of claim 1, further comprising a service subscription wizard that at least partially automates the assignment of relationships of CI's to BSE's.

16. The method of claim 15, wherein the service subscription wizard automatically assigns relationships of CI's to BSE's during an initial implementation of the method.

17. The method of claim 15, wherein the service subscription wizard automatically creates and modifies assigned relationships of CI's to BSE's when changes to the configuration of CI's within the IT system take place.

18. The method of claim 15, wherein the service subscription wizard automatically obtains information from data sources available within the IT system regarding at least one of enumeration of CI's in the IT system and configuration of CI's in the IT system.

19. The method of claim 15, wherein the service subscription wizard maintains a database of information regarding relationships of CI's to BSE's in a Configuration Management Database
